(19) United States
(12) Patent Application Publication
(10) Pub. No.: US 2009/0137170 A1
(43) Pub. Date: May 28, 2009

(54) Non-Woven Colour-Catcher Fabric and Method for its Preparation

(75) Inventors: Marco Luoni, Busto Arsizio (VA) (IT); Giuseppe Li Bassi, Gavirate (Va) (IT)

Correspondence Address: PAUL S MADAN;MADAN, MOSSMAN & SRIRAM, PC, 2603 AUGUSTA DRIVE, SUITE 700, HOUSTON, TX, 77057-5662, US

(73) Assignee: LAMBERTI SPA, Albizzate (VA) (IT)

(21) Appl. No.: 12/162,557

(22) PCT Filed: Jan. 29, 2007
(86) PCT No.: PCT/EP2007/050824

§ 371 Date: Jul. 29, 2008

(30) Foreign Application Priority Data
Feb. 1, 2006 (IT) VA/2006/A/0006

(51) Int. Cl. B32B 5/02; D06M 15/423

(52) U.S. Cl. 442/71; 8/115.6; 8/636

(57) ABSTRACT

Procedure for preparing a non-woven colour-catcher fabric comprising the following steps: a) a cationic dye sequestering agent is applied on a non-woven fabric; b) the non-woven fabric is dried at a temperature comprised between 120 and 180° C.; c) a printing paste comprising an anionic polyacrylic dispersant or a sulfonated aromatic-formaldehyde condensation product having dispersing properties is applied on the non-woven fabric by printing technique.

### . TECHNICAL FIELD

The present invention relates to a colour-catcher non-woven fabric

that can be added to the washing liquor while clothes are laundered in order to prevent the redeposition of released dyes on clothes.

The invention also relates to a method for the preparation of the a colour-catcher non-woven fabric.

### BACKGROUND ART

The problem of undesired discoloration of garments and linen is well known in home and industrial laundering; discoloration originates from the disassociation from clothes and migration to water of some amount of dye, and absorption of dyes on other clothes having a lighter or different colour.

Prior attempts to solve this problem have been directed toward better fixing dyes on fabrics, avoiding simultaneous washing of clothes of different colours, adding to the wash liquor, mainly through the washing powder, a dye sequestering agent.

During the last years, the use in washing machines of specifically treated textile or cellulosic articles as colour scavengers (colour-catchers) to avoid redeposition of dyes onto clothes has became more and more widespread.

Among the oldest patents related to colour scavenging articles, we cite U.S. Pat. No. 4,380,453 and IE 80829; they describe textile substrates treated with quaternary ammonium salts, and in particular with glycidyl trimethyl ammonium chloride, and their use as dye sequestering agents.

U.S. Pat. No. 4,380,453 describes the preparation of the cloth by cold dipping padding; this type of preparation is rather cumbersome and tedious and the cloth is not particularly suited for repeated use.

The process of IE 80829 requires a dipping treatment of the cloth, and, also, a heating step at a temperature comprised between 30 and 40° C. under specific pressure, centrifugation, a further immersion of the cloth in an acidic bath, another step in which the cloth is subjected to pressure and final drying.

U.S. Pat. No. 5,698,476 describes a dye scavenging article comprising a dye absorber and a dye transfer inhibitor that is delivered up from the support matrix to the wash liquor, acting as a dye suspending agent.

The use of cationic polymers as dye sequestering agents is well known in the art, and their drawbacks too.

The main disadvantage of cationic polymers is generally their solubility in water, together with their tendency to be absorbed on clothes, where sequestered dyes become definitely fixed.

To obviate this problem, it has been proposed to chemically or physically link the polymer by means of cross-linking to the colour-catcher article, thus rendering it insoluble, as described for example in U.S. Pat. No. 6,833,336 and U.S. Pat. No. 6,887,524.

Unfortunately, the procedure for the preparation of the colour-catcher article of U.S. Pat. No. 6,833,336 is problematic, as it is remarked in U.S. Pat. No. 6,887,524; the procedure of U.S. Pat. No. 6,887,524 requires two successive treatments (with the polymer and with the cross-linking agent) and perfect control of the completeness of the cross-linking reaction, which takes place by heating the support.

It has now been found that it is possible to prepare a non-woven colour-catcher fabric by treating a non-woven fabric with a cationic sequestering agent, particularly a cationic polymer, and subsequently applying on its surface, by printing technique, an anionic polymeric dispersing agent.

The non-woven colour-catcher fabric prepared by the procedure of the present invention is particularly efficient and avoids the migration of the cationic sequestering agent onto the clothes during washing.

It is supposed that the dispersing agent applied by printing technique, keeps dispersed in the wash liquor the traces of dyes that the cationic dye sequestering agent could not sequester and also prevents fixing on clothes of the small amount of sequestering agent possibly delivered from the non-woven fabric, that would cause their undesired discoloration.

### DISCLOSURE OF INVENTION

It is therefore an object of the present invention a procedure for rendering a non woven fabric capable of absorbing dyes comprising the following steps: a) a cationic dye sequestering agent is applied on a non-woven fabric; b) the non-woven fabric is dried at a temperature comprised between 120 and 180° C.; c) a printing paste comprising an anionic polyacrylic dispersant or a sulfonated aromatic-formaldehyde condensation product having dispersing properties is applied on the non-woven fabric by printing technique.

It is another object of the present invention a non-woven colour-catcher fabric containing a cationic dye sequestering agent characterised by the fact that its surface is treated with a printing paste comprising an anionic polyacrylic dispersant or a sulfonated aromatic-formaldehyde condensation product having dispersing properties.

The invention further relates to a printing paste comprising an anionic polyacrylic dispersant or a sulfonated aromatic-formaldehyde condensation product having dispersing properties.

Best results were obtained by using a polymeric cationic dye sequestering agent, and in particular a non-crosslinked imidazole-epichlorohydrin copolymer having molecular weight lower than 10,000 as the polymeric cationic dye sequestering agent.

More preferably, useful non-crosslinked imidazole-epichlorohydrin copolymers have molecular weight (M_{w}) from 2,000 to 8,000 dalton, as determined by GPC (eluent 0.10 M Na₂SO₄, column Ultrahydrogel Millipore, detector based on refractive index and differential viscosimetry)

When a non-crosslinked imidazole-epichlorohydrin copolymer is used as the polymeric cationic dye sequestering agent, the method by which it is applied to the non-woven fabric in step a) does not affect the efficacy of the final article; that is, in step a) the dye sequestering agent can be applied by padding or by exhaustion, provided that the non-woven fabric has linked the maximum possible amount of dye sequestering agent; it was nevertheless noticed that it is preferably to perform step a) by hexaustion using a beam dying machine, to preserve the non-woven fabric from any damage and dimensional deformations.

The beam dyeing machine is a discontinuous dyeing machine in full width, essentially made of an autoclave, inside which the goods to treat is filled after rolling on a drilled beam.

Thanks to special packing and pump the dyeing liquor is forced to pass through the goods. The flow could be from exterior to interior and/or the opposite.

Regarding the present invention it is preferred to work forcing the bath from exterior to interior only so that the non-woven is always pressed to the metallic beam, avoiding in such way excessive tension on the goods.

The non-crosslinked imidazole-epichlorohydrin copolymer is preferably applied on the non-woven fabric in the form of an aqueous solution at a concentration of from 1 to 8% by weight on the weight of the non-woven fabric.

Preferably, an inorganic strong base, such as 30% aqueous NaOH, is added to the aqueous solution to increase the pH and to help fixing the copolymer to the fabric; from about 1 to about 10% of 30% aq. NaOH on the weight of non-woven fabric or equivalent amount of different strong base can be used.

In step a), when the beam dying machine is used, the weight ratio between the amount of aqueous solution and the non-woven fabric is from 10 to 30; the temperature ranges between 40 and 60° C. and the treatment is performed for 15 to 120 minutes.

Preferably, after the application of the sequestering agent, step a) also comprises a washing and neutralising step, which advantageously is carried out with a diluted aqueous solution of acetic acid.

Neutralisation avoids yellowing of the non-woven fabric during the drying of step b).

Excess of water is removed from the non-woven fabric by step b); preferably, drying is accomplishing in a convection oven for 1-10 minutes.

The anionic polyacrylic dispersant useful for the realisation of the present invention is preferably obtained by copolymerising acrylic acid and/or methacrylic with a monomer containing a strongly acidic group, such as a sulfonic group, and has molecular weight (M_{w}) comprised between 20,000 and 40,000 daltons (measured with a standard of acrylic acid); such anionic polyacrylic dispersant are commercially available and, for example, are sold by Lamberti SpA.

More preferably, the molar percentage of the monomer containing a sulfonic group is comprised between 3 and 20%; best results within this range were obtained by using as the anionic polyacrylic dispersant a copolymer of acrylic acid, methacrylic acid and 2-acrylamido-2-methyl-1-propanesulfonic acid.

Sulfonated aromatic-formaldehyde condensation product having dispersing properties are also available on the market, and are generally prepared by reacting a sulfonated aromatic compound (such as naphthalene sulfonic acids, naphthol sulfonic acids, alkylated naphthalene and alkylated naphthol sulfonic acids, as well as toluene sulfonic acids, benzene sulfonic acids, phenol sulfonic acids, and the like) with formaldehyde to form a condensation product which is neutralised or rendered alkaline by the addition of an aqueous solution of sodium hydroxide.

Among the commercially available sulfonated aromatic-formaldehyde condensation product having dispersing properties which are useful for the realisation of the present invention we cite Setamol® WS, sold by BASF.

The printing paste of step c) preferably contains an anionic polyacrylic dispersant.

The printing paste is normally applied only on one of the two sides of the fabric.

The coverage of the printed side can be full or partial and shall be at least 30%, assuming the colour-catcher is 0.24×0.15 m wide and is used to preserve from discoloration 2 Kg of clothes.

Any traditional printing technique can be used, such as for example silk printing or rotary printing.

The printing paste contains from 1 to 10% by weight of anionic polyacrylic dispersant or of sulfonated aromatic-formaldehyde condensation product having dispersing properties and it also contains water, a thickener and from 8 to 20% by weight of an acrylic binder.

The acrylic binder is preferably a polyethylacrylate, the thickener a cross-linked polyacrylate.

Printing is normally performed by rotary printing machine (as stork or similar).

The viscosity of the printing paste of step c) according to the invention shall be comprised between 8,000 and 15,000 mPa*s.

Advantageously, the printing paste also comprises from 1 to 5% by weight of a non polymeric dispersing agent, such as EDTA; nonetheless, it was observed that by using a printing paste containing EDTA as the sole ingredient with dispersing properties, it is not possible to obtain a colour-catcher article having the same performance of the colour-catcher of the invention.

It is supposed that the anionic polymeric dispersing agent is more efficient in blocking the residues of cationic dye sequestering agent which are not linked to the non-woven fabric.

The non-woven fabric useful for the realisation of the present invention is a cellulosic fabric; preferably it is a viscose or Lyocell® fabric and has a weight of 20-200 g/m².

It is also possible to use the procedure of the invention for rendering a traditional, natural or regenerated, cellulosic fabric capable of absorbing dyes, that is, it is possible to use the procedure of the invention to prepare a woven colour-catcher fabric, although the use of non-wovens is preferred for economical reasons.

According to a particular embodiment of the invention, in step c) from 10 to 30 g/m² of total dried matter including from 1 to 6 g/m² of anionic polymeric dispersing agent are applied on the non-woven fabric.

During step c) it is possible to print on the non-woven fabric a decorative pattern which is optionally evidenced by laundering, by adding to the printing paste a “fugitive dyestuff”, a dye that disappears on laundering; the dyes absorbed by the non-woven fabric become fixed only where the surface is not treated with the printing paste, thus showing the effectiveness of the colour-catcher of the invention.

After printing, the non-woven fabric is dried at a temperature comprised between 30 and 150° C., preferably at about 130° C.

The non-woven fabric of the invention is characterised by the fact that it contains a cationic dye sequestering agent, preferably a polymeric cationic dye sequestering agent, and by the fact that its surface is treated with a printing paste comprising an anionic polyacrylic dispersant or a sulfonated aromatic-formaldehyde condensation product having dispersing properties.

Preferably, the polymeric cationic dye sequestering agent is a non-crosslinked imidazole-epichlorohydrin copolymer and the printing paste comprises an anionic polyacrylic dispersant, as described above.

It is a further object of the present invention a printing paste comprising from 1 to 10% by weight of an anionic polyacrylic dispersant, preferably a copolymer of acrylic acid, methacrylic acid and 2-acrylamido-2-methyl-1-propanesulfonic acid, an acrylic binder, a thickening agent and water and having Brookfield viscosity of from 8,000 to 15,000 mPa*s.

The performance of a 0.05 m² wide non-woven colour-catcher fabric of the invention was evaluated by comparing it with commercially available colour-catcher articles having same dimensions, by dying with a laboratory machinery, for 30 minute at 40° C., 0.05 m² wide white multifiber fabric, in water containing 0.2 g/l of a violet or blue dye.

The performance of the non-woven colour catcher fabric of the invention was found to be similar to the performance of the best colour-catcher articles.

### EXAMPLE 1

### Preparation of the Printing Paste P1

The following ingredients (pp=parts by weight) are mixed in the order:

| | | |
|---|---|---|
| water | 600 | pp |
| binder | 300 | pp |
| anionic polyacrylic dispersant | 60 | pp |
| disodium EDTA | 40 | pp |
| acrylic thickener | 45 | pp |
| Tintex B | 20 | pp |

(the binder is an acrylic binder, and in particular a 45% by weight polyethylacrylate; the anionic polyacrylic dispersant is a copolymer of acrylic acid, methacrylic acid and 2-acrylamido-2-methyl-1-propanesulfonic acid, 35% of dried matter; Tintex is a fugitive dyestuff sold by Lamberti SpA).

The printing paste P1 is obtained, having Brookfield viscosity of 8,500 mPa*s.

### EXAMPLE 2

### Preparation of the Printing Paste P2

The following ingredients (pp=parts by weight) are mixed in the order:

| | | |
|---|---|---|
| water | 600 | pp |
| binder of Ex. 1 | 300 | pp |
| anionic polyacrylic dispersant of Ex. 1 | 60 | pp |
| disodium EDTA | 40 | pp |
| acrylic thickener | 150 | pp |
| fugitive dyestuff | 20 | pp |

The printing paste P2 is obtained, having Brookfield viscosity of 15,600 mPa*s.

### EXAMPLE 3

### Preparation of the Printing Paste P3

The following ingredients (pp=parts by weight) are mixed in the order:

| water | 430 | pp |
|---|---|---|
| binder of Ex. 1 | 428 | pp |
| anionic polyacrylic dispersant of Ex. 1 | 85 | pp |
| disodium EDTA | 57 | pp |
| acrylic thickener | q.s. to obtain a viscosity | |
| | of 13,000 mPa*s | |
| Tintex B | 7 | pp |

The printing paste P3 is obtained.

### EXAMPLE 4

### Preparation of a Comparative Printing Paste

The following ingredients (pp=parts by weight) are mixed in the order:

| water | 430 | pp |
|---|---|---|
| binder of Ex. 1 | 428 | pp |
| disodium EDTA | 57 | pp |
| acrylic thickener | q.s. to obtain a viscosity | |
| | of 13,000 mPa*s | |
| Tintex B | 7 | pp |

The comparative printing paste P4 is obtained.

### EXAMPLE 5

### Preparation of a Non-Woven Colour Catcher Fabric According to the Invention

An aqueous solution containing 4% by weight (based on the weight of the non-woven fabric) of a 25% by weight imidazole-epichlorohydrin copolymer and 0.5 g/l of Biorol JK (quickly biodegradable nonionic low foaming wetting agent sold by Lamberti SpA) is prepared.

The solution is charged into the beam dyeing machine, and heated at 50° C. and a non-woven Lyocell® fabric (70 g/m²) is treated for 15 minutes.

Slowly, 4% by weight (based on the weight of the non-woven fabric) of 36 Bé NaOH is added to the solution. The temperature is maintained at 50° C. for 10 more minutes, the bath is discharged and the non-woven fabric is washed with water containing acetic acid.

The non-woven fabric is dried at 180° and printed (coverage 50%) with a Stork printing rotary screen (60 mesh) with the printing paste P3 (dried matter applied: 16 g/m², printing paste applied 70 g/m²).

The non-woven fabric is dried at 130° C. and the colour-catcher A is obtained.

### EXAMPLE 6

### Preparation of a Comparative Non-Woven Colour Catcher Fabric

The procedure of Example 5 is repeated, but using the comparative printing paste P4 instead of P3.

### EXAMPLE 7

The performances of the colour-catcher A (according to the invention) and of the comparative colour-catcher of Example 6 are evaluated, both with a direct violet dye and with a blue direct dye, as previously described.

It is observed that the colour-catcher A maintains perfectly white the multifiber fabric in the washing bowls, while, when the colour-catcher of Example 6 is used, a light shade irregularly coloured multifiber fabric is recovered.

### EXAMPLE 8

Two flannel fabrics (100% cotton, 7 g) are dyed with two solutions (water with hardness 30° F.) containing 0.06 g/l of Direct Violet (C.I. 47); in one of the two solutions a 0.3 g colour catcher, prepared as described in Example 3, is also present. Dying is accomplished at 40° C. for 20 minutes.

At the end of the treatment the dyeing yield was compared, assuming as 100% the shade obtained on the fabric dyed without the colour catcher sample.

The flannel fabric dyed jointly with the colour catcher had 53% in yield respect to the one dyed without colour catcher; this means that 47% of the available dyestuff was adsorbed by the little colour catcher sample.

The chromatic yield measure was done by a “Datacolor” colour match at 540 nm wavelength (which is the highest absorbance wavelength for this kind of dyestuff).

1-16. (canceled)

17. A method for rendering a non woven fabric capable of absorbing dyes comprising:
a cationic dye sequestering agent is applied on a non-woven fabric;
the non-woven fabric is dried at a temperature of from about 120 to about 180° C.; and
a printing paste comprising an anionic polyacrylic dispersant or a sulfonated aromatic-formaldehyde condensation product having dispersing properties is applied on the non-woven fabric by printing technique.

18. The method of claim 17, wherein the cationic dye sequestering agent is polymeric.

19. The method of claim 18, wherein the polymeric cationic dye sequestering agent is a non-crosslinked imidazole-epichlorohydrin copolymer.

20. The method of claim 19, wherein the copolymer is used in the form of an aqueous solution.

21. The method of claim 20, wherein excess of water is removed from the non-woven fabric by drying the non-woven fabric in a convection oven for from about 1 to about 10 minutes.

22. The method of claim 19, wherein the printing paste comprises an anionic polyacrylic dispersant.

23. The method of claim 22, wherein the anionic polyacrylic dispersant is:
obtained by copolymerizing acrylic acid and/or methacrylic acid with a monomer containing a sulfonic group; and
has molecular weight of from about 20,000 to about 40,000 Daltons.

24. The method of claim 23, wherein the anionic polyacrylic dispersant is a copolymer of acrylic acid, methacrylic acid and 2-acrylamido-2-methyl-1-propanesulfonic acid and the molar percentage of the monomer containing a sulfonic group is from about 3 to about 20%.

25. A non-woven color-catcher fabric containing a cationic dye sequestering agent wherein the surface of the non-woven color catcher fabric is treated with a printing paste comprising an anionic polyacrylic dispersant or a sulfonated aromatic-formaldehyde condensation product.

26. The non-woven color-catcher fabric of claim 25 wherein the cationic dye sequestering agent is polymeric.

27. The non-woven color-catcher fabric of claim 26 wherein the polymeric cationic dye sequestering agent is a non-crosslinked imidazole-epichlorohydrin copolymer.

28. The non-woven color-catcher fabric of claim 27 wherein the printing paste comprises an anionic polyacrylic dispersant.

29. The non-woven color-catcher fabric of claim 28 wherein the anionic polyacrylic dispersant is obtained by copolymerizing acrylic acid and/or methacrylic acid with a monomer containing a sulfonic group, and has molecular weight of from about 20,000 to about 40,000 Daltons.

30. The non-woven color-catcher fabric of claim 29, wherein the anionic polyacrylic dispersant is a copolymer of acrylic acid, methacrylic acid and 2-acrylamido-2-methyl-1-propanesulfonic acid and the molar percentage of the monomer containing a sulfonic group is from about 3 to about 20%.

31. A printing paste comprising:
from about to about 10% by weight of an anionic polyacrylic dispersant, or about 1 to about 10% by weight of a sulfonated aromatic-formaldehyde condensation product having dispersing properties;
from about 8 to about 20% by weight of an acrylic binder;
a thickener; and
water.

32. The printing paste of claim 31 comprising:
from about 1 to about 10% by weight of an anionic polyacrylic dispersant;
from about 8 to about 20% by weight of an acrylic binder;
a thickener; and
water.

33. The printing paste of claim 31 comprising:
from about 1 to about 10% by weight of a sulfonated aromatic-formaldehyde condensation product having dispersing properties;
from about 8 to about 20% by weight of an acrylic binder;
a thickener; and
water.
